(19) United States
(12) Patent Application Publication
(10) Pub. No.: US 2004/0223073 A1
(43) Pub. Date: Nov. 11, 2004

(54) Focal length detecting method and focusing device

(75) Inventor: Kunihiko Kanai, Chino-shi (JP)

Correspondence Address: Barry E. Bretschneider, Morrison & Foerster LLP, Suite 300, 1650 Tysons Boulevard, McLean, VA, 22102, US

(73) Assignee: Chinon Kabushiki Kaisha, Chino-shi (JP)

(21) Appl. No.: 10/774,044

(22) Filed: Feb. 9, 2004

(30) Foreign Application Priority Data
Feb. 10, 2003 (JP) 2003-032094
Dec. 26, 2003 (JP) 2003-433401

(51) Int. Cl. H04N 5/232

(52) U.S. Cl. 348/345

(57) ABSTRACT

The invention enables the accurate measurement of the distance for focusing regardless of blur of the subject image.

An image focusing area is defined in the data of a photographed image, and the image focusing area is divided into a plurality of windows. Contrast evaluated values and the position where the maximum value of the evaluated values has been recorded are calculated for each window. A plurality of images are photographed while the optical system 11 is driven to change its focal length. Of the plural image data, the portions corresponding to each window are compared one against another, and a partial focal length is calculated for each respective window. Should the positions at which the respective maximum values of the evaluated values have been recorded differ among the plural image data of a window, it is assumed that the window contains blur. As a result, the reliability of the window is reduced, and the partial focal length of the window is disregarded. Of the partial focal lengths that have been judged to be valid, the shortest or longest distance is used as the focusing position to drive the lens.

### FIELD OF THE INVENTION

The present invention relates to a focal length detecting method and a focusing device for detecting a focal length based on image data.

### BACKGROUND OF THE INVENTION

In some conventional image capturing apparatuses, such as video cameras and electronic still cameras, focusing a lens calls for extracting a high-frequency component of data of a captured image by capturing an image while driving the lens to move its focal point and extract high-frequency components respectively at various positions of the lens, calculating evaluated value of contrast (such a value is hereinafter referred to as contrast) based on the extracted high-frequency components, and moving the lens in such a direction as to increase the contrast. The position where the contrast is at the maximum is regarded as the focusing position of the lens.

A conventionally known example of such methods calls for dividing an image into a plurality of areas, for example 5 areas, on the screen and performing range finding by using contrast of each area (e.g. See Patent Reference Document 1). However, the method described in Patent Reference Document 1 presents a problem in that when a subject is moving or when an image blur is occurring, the area having a large evaluated value of contrast is not always the area where the subject is present; in other words, a desirable focal length may not be selected.

As disclosed in Patent Reference Document 2, there is provided a system of adjusting the focus while tracking a moving subject, thereby preventing erroneous function that would otherwise be caused by movement of the subject or camera shake. This is done by repeating a procedure that consists of steps of detecting the position of an image forming element detecting the peak value of high frequency components and changing the detecting area based on the detected position. A camera using such a system is capable of tracking a subject. However, in cases where the camera is set such that focusing is performed in a tracked area, it is necessary to drive the lens again in the area to re-evaluate the high frequency components. This presents a problem particularly in cases where the camera is an electronic still camera or the like, for which focusing is done by pushing the shutter and then driving the lens to the most appropriate focusing position. With such a camera, focusing may take such a long time that capturing the shutter release moment may be difficult. Furthermore, a change in an image capturing area causes a change in the subject detection area preset for focusing, which may result in capturing an image that is different from what the photographer thought he was taking.

As disclosed in Patent Reference Document 3, there is provided a means of increasing detection accuracy by using a moving position of a focus lens to find an area that is likely to become a focusing position and give a greater weight to the evaluated value for such an area.

As disclosed in Patent Reference Document 4, there is provided a means of dividing a focus evaluation area into a plurality of target areas and weighing a partial focus evaluated value for a target area that is appropriate for focus evaluation. The means described in Patent Reference Document 4 aims at eliminating the influence of high frequency components resulting from contrast particular to a subject by means of weighting, which is performed by reducing the weighting for a target area in which changes in partial focus evaluated values caused by movement of the focus lens or the like are small. Should an image be affected by flicker caused by a fluorescent lamp or the like, the evaluated value of a subject image at each position of the lens is affected by an evaluated value that is unrelated to the contrast. This may cause omission of a part of evaluated values and impair correct determination of the focusing position.

Yet another example of a conventionally known image capturing apparatus equipped with a focusing device has a structure which enables photography of a subject located at a far distance by compelling the lens to move to an infinity set position in accordance with the intention of the photographer, regardless of the focusing position found by the focusing device. This structure includes a means to select a photographing mode which is called the far distance mode or the infinity mode. A concrete example of such a device is an automatic focusing device having a range finding device of an active automatic focusing type or a similar type, wherein depressing a background button causes the lens to be moved to an infinity set position as the best focusing position (e.g. see Patent Reference Document 5). However, it is not always easy for the focusing device to include a means to move the lens to an infinity set position to focus the lens to the infinity; fluctuation between the dimensions of individual cameras or lenses has to be absorbed by means of adjusting operation to correct the infinity set position, which operation requires high precision and increased man-hours, resulting in increased production costs. On the other hand, a structure that calls for setting a prefixed infinity presents a problem in that environmental and other conditions at shooting, such as the temperature or a loose lens, may impair accurate focusing to the infinity so that, in some cases, the focal point moves to a position beyond the design infinity. Another problem of the structure is its inability to focus accurately at far distances other than the infinity. In addition to active automatic focusing that calls for emitting beams of light, Patent Reference Document 5 refers to range finding devices of other types, such as one that calls for observing how a subject image is formed and a method of detecting a focusing position while observing how a subject image is formed.

Conventionally known examples of methods of detecting a focus of an automatic focal point detect detecting device having a plurality of focal point detect detection areas include one that calls for a plurality of algorithms for determining the moving distance of the lens, such as a pattern recognition algorithm, a specified island algorithm, and a minimum defocus algorithm, and automatically selecting an appropriate algorithm in accordance with a camera sequence to ascertain a focused state (e.g. see Patent Reference Document 6). The method described above, however, calls for automatically ascertaining a focused state by using complex algorithms and therefore presents a problem in that it is not possible for the photographer to clearly grasping a focusing position. With a single-lens reflex camera or the like, it is possible to confirm a focusing position before shooting by means of an optical finder using a penta prism and a mirror. With an apparatus having an optical finder that is incapable of confirming focusing or a digital camera using a low-resolution liquid crystal monitor (LCD), confirmation of a focusing position is difficult. In other words, confirmation of a focusing position requires an expensive device. As the photographic resolution of such an LCD as one used in a digital camera is greater than the display resolution, confirmation of photographic depth, too, is difficult. This problem may be overcome by enlarged display, i.e. increasing the display resolution to the scale of the photographic resolution. However, in addition to limitations in the display capability (it is impossible to display all the areas used for focusing), such a system requires expensive hardware to perform real time resizing, i.e. scaling, and display of image data. As described above, a system using a plurality of algorithms presents problems of increased production cost and confirmation of a focusing position necessitating a repetition of an action of confirmation by the user.

An example of zoom lens automatic focusing devices is disclosed in Patent Reference Document 7, which describes an invention with an objective of accurate correction of focus movement resulting from changes in zoom lens magnification with respect to any distances to a subject. In order to carry out this objective, the aforementioned invention calls for performing focusing control using the hill-climbing search method and setting a threshold to start focusing for each subject distance, thereby enabling appropriate focus correction regardless of the distance to the subject while avoiding excessive lens response. This invention, however, does not take into consideration deviation of the focal point caused near the short-range end or long-range end resulting from difference in positions or orientation of the camera or temperature.

Patent Reference Document 1: Japanese Laid-open Patent Publication No. 04-83478 (Page 1, FIG. 2)

Patent Reference Document 2: Japanese Laid-open Patent Publication No. 63-94213 (Page 2, FIG. 2)

Patent Reference Document 3: Japanese Laid-open Patent Publication No. 05-199443 (Pages 5 & 8)

Patent Reference Document 4: Japanese Laid-open Patent Publication No. 2001-119623 (Pages 2 & 5)

Patent Reference Document 5: Japanese Laid-open Patent Publication No. 63-214726 (Pages 1-2, FIG. 1)

Patent Reference Document 6: Japanese Patent Publication No. 2770316 (Page 5, FIG. 1)

Patent Reference Document 7: Japanese Patent Publication No. 2585454 (Page 1, FIG. 1)

A particular problem presented by setting a plurality of focal point detecting areas and detecting a peak point of peak values of high frequency components in each focal point detecting area arises when a subject with a relatively high contrast originally in the plural focal point detecting areas is displaced from a part of the focal point detecting areas due to blur of an image or other causes, resulting in displacement of high frequency component peak values from the proper positions. Although a method which calls for selecting a short-range focusing position from a plurality of focal point detecting areas is conventionally deemed valid, using this method in a situation where the aforementioned displacement of high frequency component peak values has occurred often causes an erroneous focusing position to be chosen. Another problem of this method lies in that using this method in a conventional device requires a complicated structure, which results in an increase in production costs and makes it difficult to properly focusing on a subject located far away.

In order to solve the above problems, an object of the present invention is to provide a focal length detecting method and a focusing device which are capable of accurate detection of a focal length regardless of movement of the subject or camera shake.

### SUMMARY OF THE INVENTION

A method of detecting a focal length according to the invention calls for setting a plurality of image detecting areas adjacent to one another, obtaining multiple image data while changing the focal length of an optical system, calculating from said multiple image data a partial focal length for each image detecting area based on which image data the peak value of contrast evaluated values has been recorded in, calculating the reliability of each image detecting area based on the position at which said peak value has been recorded moving across the multiple image data, and selecting a focal length from a group consisting of said partial focal lengths and at least one given focal length, said focal length selected based on the reliability and the evaluated values of each respective image detecting area.

As each reliability factor is calculated based on the position at which the peak value of the contrast evaluated values has been recorded moving across the multiple image data so that the partial focal length of an image detecting area that has a low reliability due to relative movement of the subject is excluded from selection, the method described above enables the accurate detection of the focal length.

According to the invention, weighting of evaluated values performed based on the calculated reliability, and a focal length is selected from among the partial focal lengths of the image detecting areas based on the evaluated values thereof to which weighting has been applied.

By using evaluated values to which weighting has been applied based on a calculated reliability so that the partial focal length of an image detecting area having a low reliability is excluded from selection, the method described above enables the accurate detection of the focal length.

According to the invention, should a position at which a peak value has been recorded move from at least one image detecting area that contains said position into at least one other image detecting area, the reliability of the first-mentioned image detecting area is reduced.

With the feature described above, the method described above enables the accurate detection of the focal length by excluding the partial focal length of an image detecting area having a low reliability due to relative movement of the subject from selection.

According to the invention, should a position at which a peak value has been recorded move more than a given distance across plural image detecting areas that contain said positions at which peak values have been recorded, the reliability is reduced.

With the feature described above, the method described above enables the accurate detection of the focal length by excluding the partial focal length of an image detecting area having a low reliability due to relative movement of the subject from selection.

According to the invention, in cases where image data containing a great peak value has been obtained, the number of images to be subsequently obtained in the form of data is reduced.

With the feature described above, the method enables the reduction of time needed for focusing by obtaining only sufficient essential image data.

According to the invention, a peak point movement determining value, which is used at the time of calculation of a reliability for determining whether a position at which a peak value has been recorded has moved is a variable calculated based on photographing conditions.

With the feature described above, the method enables the detection of an appropriate focal length by setting a peak point movement determining value based on photographing conditions, thereby enabling calculation of a reliability factor more appropriate for the photographing conditions.

According to the invention, a plurality of peak point movement determining values are set for determining at the time of calculation of a reliability whether a position at which a peak value has been recorded has moved, and the peak point movement determining values are sequentially compared with the multiple image data.

By setting a plurality of peak point movement determining values and sequentially comparing these values with the image data, the method having this feature enables the setting of reliability in a plurality of levels and thereby ensures detection of an appropriate focal length.

According to the invention, the focal length is selected from among the partial focal lengths in the image detecting areas, either the partial focal length at the shortest distance or the partial focal length at the longest distance, in accordance with the operator's choice.

The method having this feature enables the selection of an accurate focal length between the shortest focal length and the longest focal length, in accordance with the intention of the operator.

According to the invention, a control means selects as the focal length either the partial focal length at the shortest distance or the partial focal length at the longest distance from among the partial focal lengths in the image detecting areas in accordance with the operator's selection of the range of photographing distance.

As the control means selects as the focal length either the partial focal length at the shortest distance or the partial focal length at the longest distance from among the partial focal lengths in the image detecting areas in accordance with the operator's selection of the range of photographing distance, the method having this feature enables the selection of an accurate focal length in accordance with the intention of the operator.

According to the invention, the focal length is selected based on the reliability between a partial focal length selected from among the partial focal lengths in the image detecting areas and a given focal length.

The method having this feature is based on a method of selecting a focal length from partial focal lengths having a high reliability, and enables the selection of an accurate focal length. Should there be no partial focal length having a high reliability or all the partial focal lengths have a low reliability, a preset focal length is used so as to prevent selection of an inaccurate focal length.

According to the invention, the focal length is selected, based on the reliability, between a partial focal length selected from among the partial focal lengths in the image detecting areas and a given focal length that has been set as a result of the operator's choice.

The method having this feature is based on a method of selecting a focal length from partial focal lengths having a high reliability, and enables the selection of an accurate focal length between the short distance and the long distance in accordance with the intention of the operator. Should there be no partial focal length having a high reliability or all the partial focal lengths have a low reliability, a preset focal length that corresponds to the operator's choice is used so as to prevent selection of an inaccurate focal length, while reflecting the intention of the operator.

A focusing device according to the invention includes an image pickup device, an optical system for forming an image on the image pickup device, an optical system driving means for changing the focal length of the optical system, and an image processing means for processing image data output from the image pickup device and controlling the optical system driving means, wherein the image processing means is adapted to obtain multiple image data while changing the focal length of the optical system by controlling the optical system driving means, define a plurality of image detecting areas adjacent to one another in each one of the multiple image data obtained as above, calculate a partial focal length for each image detecting area based on which image data the peak value of contrast evaluated values has been recorded in and also calculate the reliability of each image detecting area based on the position at which said peak value has been recorded moving across the multiple image data, and select a focal length from a group consisting of said partial focal lengths and at least one given focal length, based on the reliability and the evaluated values of each respective image detecting area.

As each reliability factor is calculated based on the position at which the peak value of the contrast evaluated values has been recorded moving across the multiple image data so that the partial focal length of an image detecting area having a low reliability due to relative movement of the subject is excluded from selection, the device described above is capable of selecting an accurate focal length and appropriate focusing.

According to the invention, the focusing device is provided with a photographing mode selecting means adapted to make selection between a short-distance priority mode and a long-distance priority mode, and the image processing means is adapted to select the focal length with priority given to either the partial focal length at the shortest distance or the partial focal length at the longest distance in accordance with the result of operation of the photographing mode selecting means.

The device having this feature enables the selection of an accurate focal length between the short distance and the long distance, in accordance with the intention of the operator. As the device is capable of performing this function without complicating its structure, production costs can be kept under control.

According to the invention, the optical system driving means is capable of driving the optical system into an overstroke range, which is a range beyond the range of focal length for which the optical system is designed.

The device having this feature enables easy and accurate focusing at a short distance or a long distance regardless of deviation of the focal point of the optical system resulting from temperature, orientation of the optical system or other conditions.

As each reliability is calculated based on the position at which the peak value of the contrast evaluated values has been recorded moving across the multiple image data so that the partial focal length of an image detecting area having a low reliability due to relative movement of the subject is excluded from selection, the present invention enables the accurate detection of the focal length.

Furthermore, the invention enables the selection of an accurate focal length between the short distance and the long distance, in accordance with the intention of the operator.

### BRIEF DESCRIPTION OF THE DRAWINGS

FIG. 1 is a block diagram of a focusing device according to an embodiment of the present invention.

FIG. 2 is a schematic illustration to explain in detail an image processing circuit of said focusing device.

FIG. 3 is a schematic illustration to explain the function of said focusing device in the state that there is no blur, wherein (a) is a schematic illustration of the relationship between windows and a subject, and (b) is a schematic illustration of a change in contrast evaluated values.

FIG. 4 is a schematic illustration of the relationship between the windows of said focusing device and the subject in a situation where there is blur.

FIG. 5 is a schematic illustration to explain the function of said focusing device in a situation where there is blur, wherein (a) is a schematic illustration of the relationship between the windows and the subject, and (b) is a schematic illustration of a change in evaluated values of contrast of the windows W4,W5.

FIG. 6 is a schematic illustration of the relationship between the windows of said focusing device and the subject in a situation where there is blur.

FIG. 7 is a flow chart showing the function of said focusing device.

FIG. 8 is a flow chart showing how said focusing device calculates the number of data images to be obtained.

FIG. 9 is a flow chart showing how said focusing device performs weighting.

FIG. 10 is a flow chart showing how said focusing device calculates a focusing distance.

FIG. 11 is a flow chart showing the function of a focusing device according to another embodiment of the present invention.

FIG. 12 is a flow chart showing the function of said focusing device.

FIG. 13 is a flow chart showing how said focusing device calculates a focusing distance.

### DETAILED DESCRIPTION OF THE PREFERRED EMBODIMENT

A focal length detecting method and a focusing device according to the present invention are explained hereunder, referring to relevant drawings.

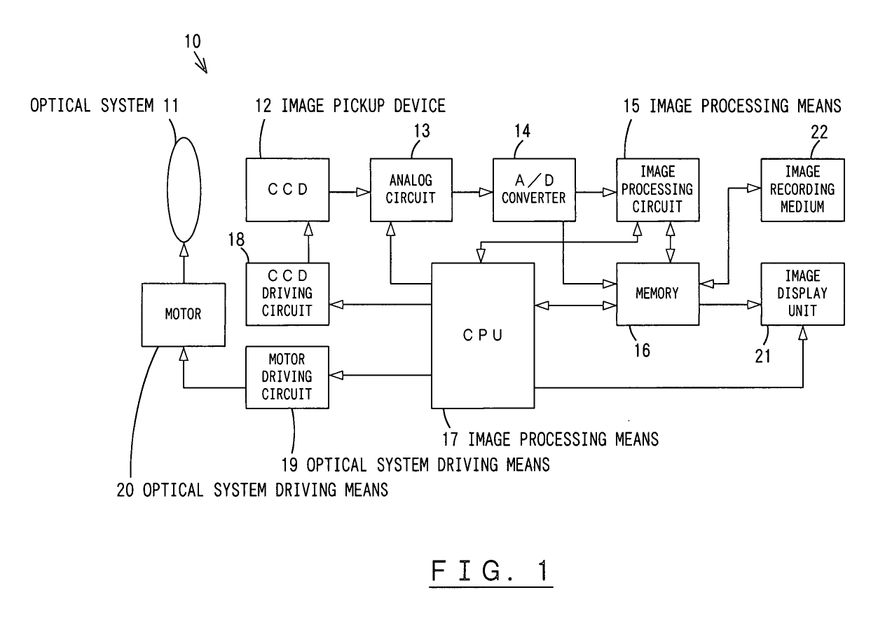

Referring to FIG. 1, numeral 10 denotes an image capturing apparatus, which is a digital camera for capturing still images and moving images and provided with a focusing device. The image capturing apparatus 10 is provided with an optical system 11 comprised of lenses, an aperture, etc., a CCD 12 as an image pickup device, an analog circuit 13 into which signals output from the CCD 12 shall be sequentially input, an A/D converter 14, an image processing circuit 15 constituting an image processing means, a memory 16 which is a RAM or the like and constitutes a recording means, a CPU 17 constituting a control means that constitutes an image processing means, a CCD driving circuit 18 adapted to be controlled by the CPU 17 so as to drive the CCD 12, a motor driving circuit 19 constituting an optical system driving means that is adapted to be controlled by the CPU 17, a motor 20 constituting an optical system driving means, a liquid crystal display or the like serving as an image display unit 21, a memory card or the like serving as an image recording medium 22, and other components that are not shown in the drawings, including a housing, a power supply unit, input and output terminals, and operating means such as a release button, switches, a photographing mode selecting means, etc. The aforementioned motor 20 is adapted to be driven by the motor driving circuit 19 so as to change the focal length by moving back and forth a lens of the optical system 11, e.g. a focus lens.

The CCD 12 is a CCD-type solid-state image pickup device, which is an image sensor using a charge-coupled device. The CPU 17 is what is commonly called a microprocessor and controls the entire system. According to the present embodiment, the CPU 17 controls the aperture and focus, i.e. focal length, of the optical system 11. The CPU 17 performs the focus control by causing through the motor driving circuit 19 the motor 20 to drive the optical system 11 so as to move a single or a plurality of focus lenses back and forth. Other functions of the CPU 17 include control of driving of the CCD 12, which is performed through control of the CCD driving circuit 18, control of such circuits as the analog circuit 13 and the image processing circuit 15, processing data to be recorded to the memory 16, control of the image display unit 21, and recording/reading of image data to or from the image recording medium 22. The memory 16 consists of an inexpensive DRAM or the like and is used by a plurality of components; it is where the CPU 17 runs programs, the CPU 17 and the image processing circuit 15 perform their respective work, input/output to and from the image recording medium 22 is buffered, and it is where other image data is temporarily stored.

The CPU 17 controls the aperture and other relevant parts of the optical system 11 to adjust the intensity of the light off subject that strikes the CCD 12. The CCD 12 is driven by the CCD driving circuit 18 so that an analog image signal resulting from photo-electric conversion of the light off subject is output from the CCD 12 to the analog circuit 13. The CPU 17 also serves to control an electronic shutter of the CCD 12 through the CCD driving circuit 18. The analog circuit 13 consists of a correlated double sampling means and a gain control amplifier and functions to remove noises or amplify analog image signals output from the CCD 12. The CPU 17 controls the degree of amplification by the gain control amplifier of the analog circuit 13 or other functions of the analog circuit 13.

The output signals from the analog circuit 13 are input into the A/D converter 14, by which they are converted into digital signals. The image signals thus converted into digital signals are either input into the image processing circuit 15 or temporarily stored directly in the memory 16 for later processing. Image signals that have been input in the image processing circuit 15 undergo image processing and then output into the memory 16, and they are subsequently either displayed on the image display unit 21 or, depending on operation by the user, recorded in the image recording medium 22 as a moving image or a still image. The unprocessed image data that has temporarily been stored in the memory 16 is processed by either one of or both the CPU 17 and image processing circuit 15.

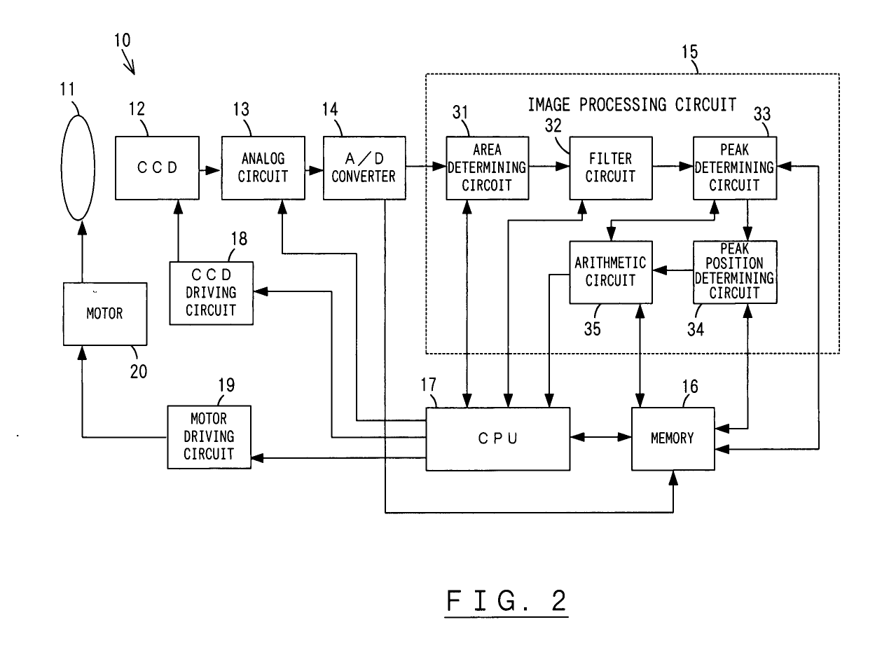

As shown in FIG. 2, the image processing circuit 15 according to the present embodiment includes an area determining circuit 31, filter circuits 32 serving as a contrast detecting means, a peak determining circuit 33, a peak point determining circuit 34, and an arithmetic circuit 35.

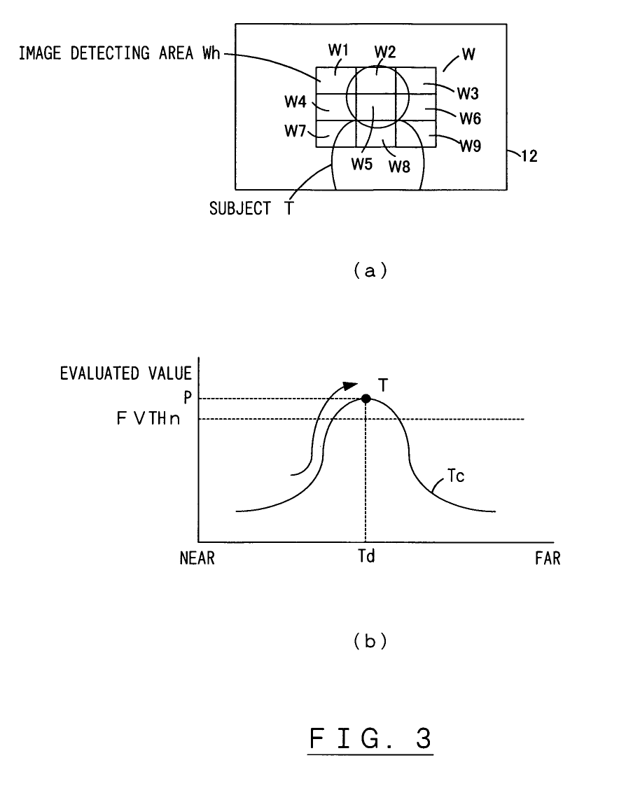

At a given lens position, in other words in the state where the optical system 11 is set at an appropriate focal length, an image of a subject entering the optical system 11 is converted into analog image signals through the CCD 12 and then into digital image data through the analog circuit 13 and the A/D converter 14. The digital image data output from the A/D converter 14 is stored in the memory 16 and is subjected to area determining processing by the area determining circuit 31 in order to determine an image focusing area W shown in FIG. 3 and other drawings. The image focusing area W is an image area used for focusing and has a plurality of image detecting areas Wh. In the case of the present embodiment, the image detecting areas Wh consist of windows W1-W9. The explanation hereunder is given based on the assumption that there is provided a means to calculate a distance from the optical system 11 to a subject T (such a distance is hereinafter referred to as the subject distance) in the windows W1-W9, in other words in the range that covers plural parts of the subject T. To be more specific, in order to determine whether the contrast is high or low in each window W1-W9 of the image focusing area W, the filter circuits 32 analyze high frequency components to calculate the contrast evaluated value for each window W1-W9. High-pass filters (HPF), which have a relatively high contrast, may desirably be used for the filter circuits 32.

According to the present embodiment, an image on each window W1-W9 is processed. To be more specific, the peak determining circuit 33 determines the highest value of the evaluated values that have been calculated by the filter circuits 32, each of which is adapted to process each respective horizontal line of each window W1-W9. The peak determining circuit 33 outputs said highest value as the evaluated value for each respective window W1-W9. The position of a highest value on image data, which value has been determined by the peak determining circuit 33, is called a peak point. Each peak point is calculated by the peak point determining circuit 34 from the starting point of each respective window W1-W9 currently undergoing calculation. Outputs from the peak determining circuit 33 and the peak point determining circuit 34, in other words the peak values of the contrast evaluated values of the respective horizontal lines in the windows W1-W9 and the peak points at which the peak values have been recorded, are temporarily stored in the memory 16.

The peak values and peak points calculated for the horizontal lines of the CCD 12 are summed up by the arithmetic circuit 35 in each window W1-W9 so that the summed peak value and the summed peak point of each window W1-W9 are output as the value of each window W1-W9 from the arithmetic circuit 35 to the CPU 17. The aforementioned “summed peak point” means the average position with respect to the horizontal direction. The arithmetic circuit 35 is an adder which serves as a calculating means. For calculation of summed peak values of the respective windows W1-W9, the arithmetic circuit 35 may be adapted to carry out calculation only for peak values higher than a given level.

The optical system 11 is driven to change the lens position within a set range, i.e. the driving range, so that summed peak values and summed peak points are calculated at each lens position and stored in the memory 16. The aforementioned driving range, in other words the number of images to be captured for focusing, may be set appropriately based on the magnification of the lens, the photographing distance, various photographing conditions set by the photographer, etc. In case of a short subject distance, such as when a calculated evaluated value is higher than a given value, i.e. FVTHn shown in FIG. 3(b), the driving range may be reduced to shorten the duration of focusing.

The peak values of each window W1-W9 are compared within the driving range. When there is a peak in the peak values with respect to the driving direction of the lens, it is regarded as the peak of the corresponding window W1-W9.

As it can be surmised that focusing on the subject T can be accomplished in the vicinity of said peak, a focal length surmised from the value of the peak is regarded as the partial focal length of each respective window W1-W9.

The plural windows W1-W9 constitute the image focusing area W. Therefore, if there is a window where the subject T is moving near the peak, there should be others where the subject T is captured with great certainty near the peaks of the windows without blur.

In other words, the partial focal lengths of the windows W1-W9 consist of those with a high reliability, i.e. valid values, and those with a low reliability, i.e. invalid values. Therefore, using results of calculation of the peak values and peak points, the CPU 17 evaluates the reliability of each window W1-W9, in other words, it applies weighting to the focusing position determining means.

For example, should the average of the peak points of a window W1-W9 be rapidly moving near the partial focal length of the window, or the average of the peak points of a window W1-W9 that is horizontally adjacent thereto be rapidly moving, it can be surmised that blur is occurring due to movement of the subject T. In such a case, the weight on the first-mentioned window W1-W9 is reduced. When there is no significant change in the average of the peak points, the weight is not reduced, because it is judged that the subject T is not moving.

Should the peak point of a subject T in a window move into another window, the peak values and peak points of the first-mentioned window change significantly. Therefore, the reliability of a window where the peak value and peak point have changed significantly is reduced by reducing the weight on such a window so that the partial focal lengths in which the subject T are captured are given priorities.

This embodiment calls for evaluating contrast peaks in the windows W1-W9 with respect to the horizontal direction. Therefore, as long as there is a contrast peak of the subject T in a window W1-W9, the evaluated value for the window does not change regardless of movement of the subject T.

A fluctuation of peak points of peak values occurring whenever the lens is moved usually means noises or the like, in other words the absence of contrast in the pertinent window. If such is the case, it is determined that the subject T is not present in the window, and the weight on the window is reduced.

The amount of weight may be set beforehand or calculated from evaluated values of image data or other similar factors based on various photographing conditions, such as brightness data, lens magnification, etc.

The CPU 17 multiplies an evaluated value by a weight factor, thereby obtaining a weighted evaluated value of each respective window W1-W2.

Should the weighted evaluated value be less than a given value, the CPU 17, which serves as a determining means, regards the evaluated value to be invalid and does not use it thereafter.

By summing up weighted evaluated values at each lens driven position, the CPU 17 serving as a selecting means calculates a final focusing position, where the contrast is at the maximum. To be more specific, when a calculated result of the evaluated values is input into the CPU 17, the CPU 17 performs calculation by summing up the evaluated values, i.e. the summed peak values and the summed peak points of the windows W1-W9 with the position of the subject at the current lens position used as an evaluated value. At that time, the center of gravity of the peak points can be found when the peak point is a value obtained by dividing the sum of the evaluated values by the number of vertical lines in each window W1-W9. After reducing the weight on the evaluated value for each window in which there is a great change in the center of gravity or a horizontal window from which the center of gravity has moved to a corner of the window, the evaluated values for the windows are summed up to produce a final evaluated value.

The CPU 17 selects as the focusing distance the shortest partial subject distance selected from among the evaluated values that have been judged to be valid. To be more specific, based on the amount of the aforementioned final evaluated value, the CPU 17 commands movement of the lens of the optical system 11 to the position having the highest final evaluated value by means of the motor driving circuit 19 and the motor 20. Should there be no change in the final evaluated value, the CPU 17 outputs a command to stop the motor 20 through the motor driving circuit 19.

As weighting prevents error in selecting the peak due to blur of the subject T, the subject T can be correctly captured by means of calculation of plural focal lengths using a plurality of areas without the problem of erroneously picking up blur. Therefore, the method described above enables reliable selection of correct focusing position by using autofocusing that gives priority to a short range, which is generally deemed effective.

The in-focus position of the lens constituting the optical system, i.e. the position at which the lens is focused at a given distance, changes with respect to the range of photographing distance for which the lens is designed, depending on fluctuation resulting from the lens magnification, a change resulting from a change in aperture, as well as temperature, position and other conditions of the lens barrel supporting the lens. Therefore, taking into consideration the degree of change resulting from changes in these various conditions in addition to the driving range calculated from the range within which the lens is designed to be focused, the optical system 11 is provided with overstroke ranges at the short-range end and the long-range end respectively. An overstroke range is a range in which the lens is permitted to move by the distance corresponding to the degree of change. Furthermore, the control means, which is comprised of the CPU 17 or the like, is adapted to be capable of moving the lens into an overstroke area.

For example, given that the total moving distance of the in-focus position of the lens is 10 mm and that the maximum integrated value of the degree of change is 1 mm when the aforementioned designed range of photographing distance is 50 cm to infinity, a 1 mm overstroke range is provided at each end, i.e. the short-range side and the long-range end so that the lens driving range, i.e. the total moving distance of the in-focus position of the lens, is set at 12 mm (10 mm+1 mm+1 mm). By thus providing overstroke ranges and permitting to drive the lens to the overstroke ranges, the designed range of photographing distance is ensured.

Next, how autofocusing is performed in the photographing mode according to the present embodiment is explained hereunder, referring to FIGS. 3 through 10.

First, the autofocusing function in cases where there is no camera shake or the like causing blur of the subject is explained, referring to FIG. 3.

As shown in FIG. 3(a), the present embodiment calls for the image focusing area W to be situated at the center of the CCD 12 and divided into a total of nine portions, i.e. three portions horizontally by three portions vertically, so as to form windows W1-W9. However, the image focusing area W may consist of any appropriate number of windows, provided that each window is adjacent to a plurality of other image detecting areas. The subject T is positioned so that the windows W1-W9 sufficiently capture its contrast when there is no significant blur of the subject.

A result of evaluation of contrast in the state shown in FIG. 3(a) is represented by a curve Tc shown in FIG. 3(b). The example shown in FIG. 3(b) represents the final evaluated value resulting from summing up the evaluated values produced by evaluating multiple image data obtained by capturing the subject T with the optical system 11, which is driven by the motor 20 to move its focus from the short range (“NEAR”) to the long range (“FAR). FIG. 3(b) clearly shows that the subject distance Td is at the peak P of the evaluated values.

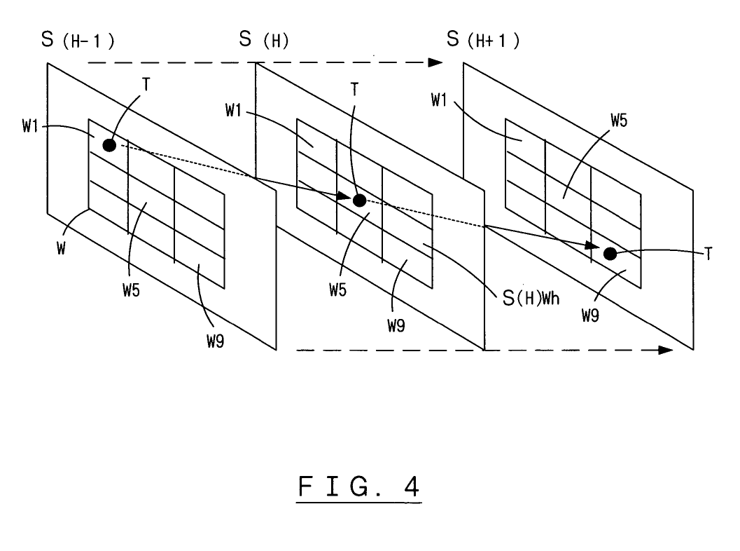

Next, the autofocusing function in cases where there is blur of the subject due to camera shake or other causes is explained hereunder, referring to FIGS. 4 through 6.

First, referring to FIG. 4, an explanation is given of how a method that uses a plurality of image detecting areas copes with blur caused by camera shake, movement of the subject, or other similar causes.

FIG. 4 illustrates camera shake during autofocusing, i.e. a situation where the image capturing apparatus 10 inadvertently moves relative to the subject T by showing images for focusing obtained by inputting image data while shifting the position of the lens of the optical system 11 in the process from a scene S(H−1) through a scene S(H) to a scene S(H+1) in time sequence. FIG. 4 shows as an example a case where a subject T is in the window W1 in the scene S(H−1). Upon occurrence of movement of the subject or camera shake, the part of the subject T with a large contrast moves to the window W5 in the scene S(H) and to the window W9 in the scene S(H+1). Therefore, should the contrast evaluated value be evaluated using only a specific window, e.g. the window W1, in this state, accurate evaluation cannot be performed.

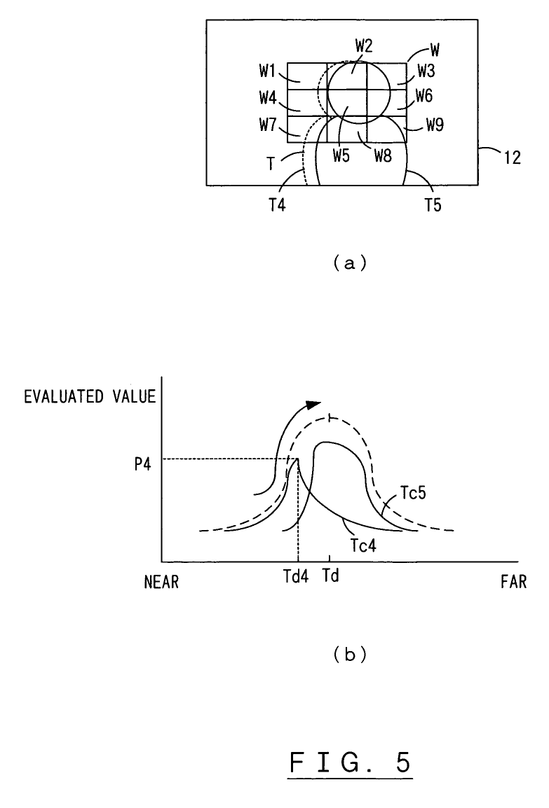

FIG. 5, too, illustrates a situation where camera shake occurs during autofocusing. FIG. 5(a) shows an image focusing area W which is similar to the one shown in FIG. 3(a). In the image focusing area W shown in FIG. 5(a), however, the subject T appears to move from the position represented by the broken line T4 to the position represented by the solid line T5, thereby generating blur in which there appears to be movement, for example, relative to the windows W4,W5 on the part of the subject T with a large contrast from the window W4 to the window W5. Should focusing be performed by driving the lens of the optical system 11 during this movement of the subject T from the window W4 to the window W5, the evaluated value resulting from evaluation of the contrast of the window W4 and the evaluated value resulting from evaluation of the contrast of the window W5 are respectively represented by the curve Tc4 and the curve Tc5 as shown in FIG. 5(b). Now, let us take as an example the curve Tc4, which is the evaluated value for the window W4; the position Td4, which does not correspond to the actual subject distance Td serves as the peak P4 of the evaluated values, and employing the peak P4 may impair discrimination of a plurality of subjects located at different distances or cause other errors.

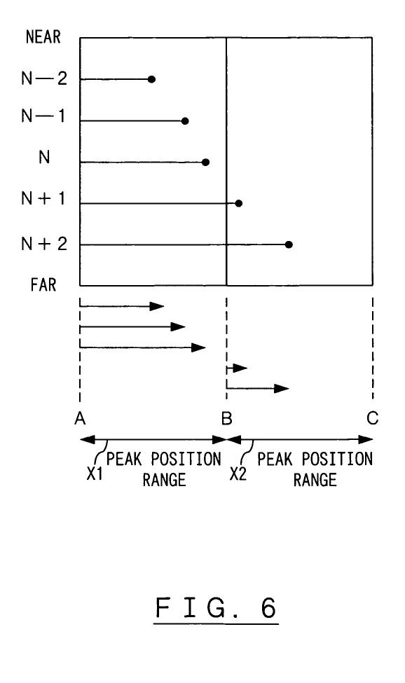

A peak point that appears to move in the windows W1-W9 is shown in FIG. 6. When the subject T is moving in the horizontal direction, the range of the peak point is determined by the number of pixels arranged along each horizontal line in each window W1-W9. X1 in FIG. 6 represents the peak point when the peak point reference point in the window W4 in FIG. 5(a) is denoted by A, and X2 represents the peak point when the peak point reference point in the window W4 in FIG. 5(a) is denoted by B. When the focal length, i.e. the lens position, of the optical system 11 is denoted by N, a range closer than N (towards NEAR) is denoted as N−1 and a range farther than N (towards FAR) is denoted as N+1. The point when the lens position of the optical system 11 moving towards FAR from N−1 reaches N+1 is when the peak point has moved from the window W4 into the window W5. In this state, blur of the subject can be easily detected even during autofocusing, because the change in the peak point is obvious.

Unless the portion with the high contrast moves across a plurality of windows, there are windows, e.g. the window W9, that have correct evaluated values even during occurrence of blur of the subject. Therefore, the correct peak point of the evaluated values can be calculated by detecting a portion where the peak point changes across a plurality of windows and reducing the weights on the evaluated values for the windows in which such a change has occurred.

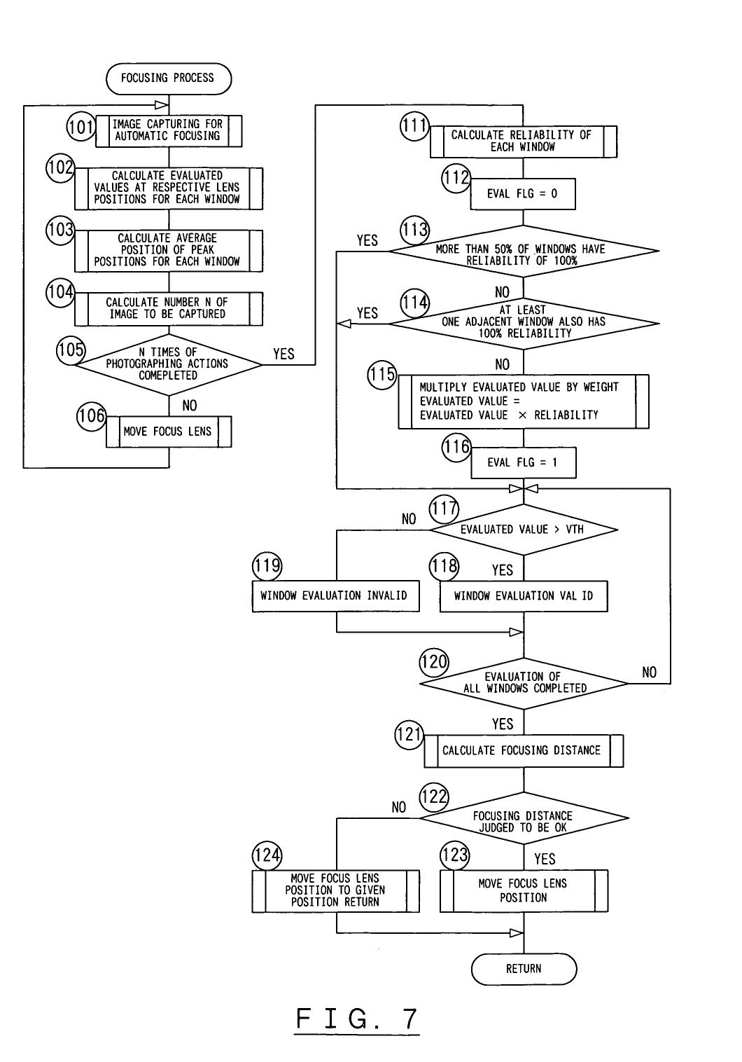

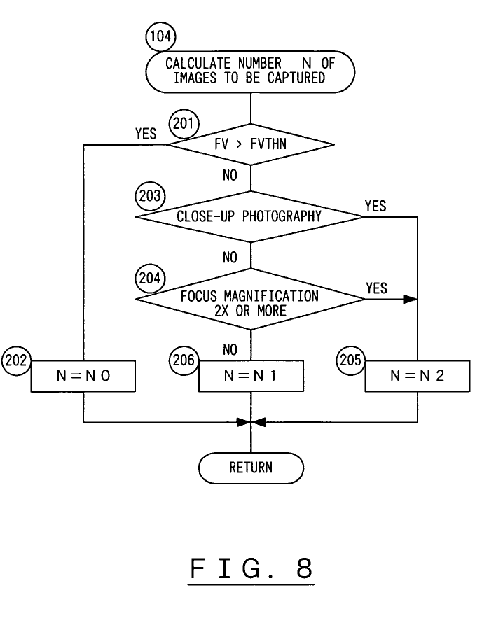

The method of controlling autofocusing that calls for weighting described above is explained hereunder, referring to flowcharts shown in FIGS. 7 through 10. FIG. 7 shows the overall process of focusing, and each one of FIGS. 8 through 10 shows in detail a part of the focusing process shown in FIG. 7.

As shown in FIG. 7, multiple image data is used to perform focusing. First, in order to obtain image data of an image focusing area W, one frame of a picture is taken for automatic focusing processing at the initial position or the current position of the lens (Step 101). Using the data of the photographed image, a contrast evaluated value for each window W1-W9 of the image focusing area W is calculated (Step 102). When calculating each contrast evaluated value, peak values of all the lines in the each respective window W1-W9 are summed up. Then, the average position of the subject T is calculated by finding relative positions of each of the peak values of all the lines in each window W1-W9 from a reference position in the each respective window W1-W9 and summing up these relative positions (Step 103). The number N of frames to be photographed is calculated (Step 104), and until N times of photographing actions are completed (Step 105), photographing actions are repeated while moving the lens of the optical system 11 (Step 105). In other words, lens moving and picture taking for focusing are repeated N times (Steps 101-106) to obtain evaluated values of continuous image data.

In cases where the position of the lens driven in Step 106 is relatively close to the distance to the subject T, the average position calculated in Step 103 based on the image data captured for focusing in Step 101 sufficiently reflects the characteristics of the main contrast of the subject T. Therefore, especially in cases where camera shake or other incident causes movement of the subject in a window in which the camera position is close to the distance to the subject T, a change in the average of the peak points is inevitable.

An explanation is now given of the process of calculating the number N of frames to be photographed for focusing (Step 104), referring to the flow chart shown in FIG. 8.

The purpose of setting the number N of frames to be photographed is to obtain sufficient essential image data by changing the number N of frames to be photographed based on the lens magnification of the optical system 11, the data of the distance to the subject T to be photographed, various photographing conditions set by the photographer, etc.

First, the evaluated value FV for each window W1-W9 calculated in Step 102 in FIG. 7 is compared with a given reference value FVTHn (Step 201). When the evaluated value FV is greater than the reference value FVTHn, N0 is input as N (Step 202). Step 201 may be omitted. N0 may be input as a variable based on the focus magnification for N. When the evaluated value FV is not greater than the reference value FVTHn (Step 201) in a situation where close-up photography is or has been chosen (Step 203) by the photographer who is operating the image capturing apparatus 10, or where the focus magnification is relatively large (for example 2× or more) (Step 204), N2 is input as N (Step 205). Under conditions other than those described above, in other words when the evaluated value FV is not greater than the reference value FVTHn (Step 201) in a situation where short-range photography is not chosen (Step 203) and where the focus magnification is relatively small (for example less than 2×) (Step 204), N1 is input as N (Step 206). The values N0, N1, N2 are smaller in the indicated order (N0<N1<N2). To perform short-range photography or when the focus magnification is large, meticulous evaluation is enabled by setting a large number N of images to be captured to provide minute setting for driving the lens of the optical system 11. On the other hand, when the subject T is located close to the optical system 11 (for example, when the calculated evaluated value FV is greater than a given reference value FVTHn), duration of focusing can be reduced by setting a small number N of images to be captured. In short, by providing a means to selectively set the lens driving range based on an evaluated value, the duration of focusing can be reduced without impairing precision of focusing.

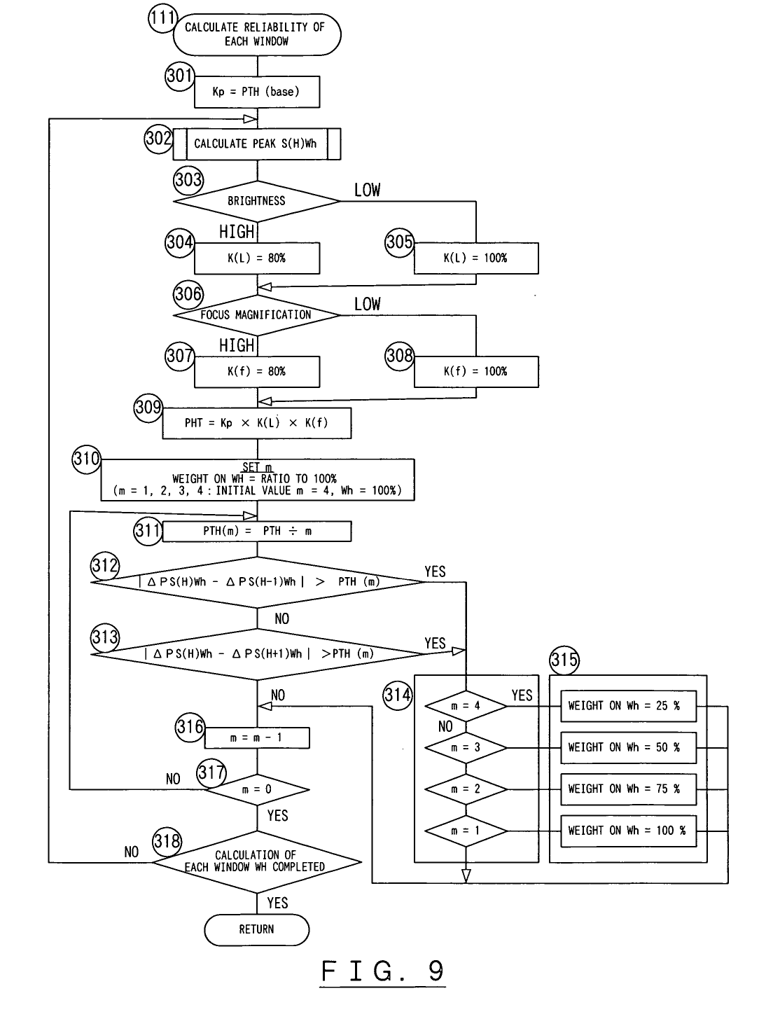

As shown in FIG. 7, judgment is made as to whether there is camera shake or like affecting an average position of the peak points obtained through the N times of photographing actions, and the amount of weight, which represents the reliability, to be placed on each window W1-W9 is calculated (Step 111). Next, how the determining circuit calculates the amounts of weights is explained in detail, referring to the flow chart shown in FIG. 9.

First, Kp=PTH(base), which represents an initial value of the moving distance of peak value average positions (PTH) is set beforehand (Step 301). Then, each window Wh of the image focusing area W, in which a number of scenes are captured, is examined to determine a single or plural scenes S(H)Wh that presents the highest evaluated value (Step 302).

The peak value average position moving distance PTH is used as a final control value for selecting the amount of weight on each window Wh. The peak value average position moving distance PTH is a variable that changes based on photographing conditions, such as the brightness, focal length, etc.

In cases where the brightness in a photographed scene is relatively high (Step 303), the moving distance in a window tends to be reduced because of an increased shutter speed. Therefore, in order to reduce the peak value average position moving distance PTH to a level lower than the preset initial value Kp=PTH(base), the ratio K(L) by which the initial value PTH(base) will be multiplied is set at, for example, 80% (Step 304). Should the brightness be not high, in other words, for example, should it be rather low (Step 303), the ratio K(L) is set at, for example, 100% (Step 305). In cases where the focus magnification is relatively high (Step 306), there is a higher possibility of camera shake than when focus magnification is low. Therefore, in order to reduce the peak value average position moving distance PTH to a level lower than the preset initial value PTH(base), the ratio K(f) by which the initial value PTH(base) will be multiplied is set at, for example, 80% (Step 307). Should the focus magnification be not high, in other words, for example, should it be rather low (Step 307), the ratio K(f) is set at, for example, 100% (Step 308).

The peak value average position moving distance PTH, which serves as the most appropriate control value for the photographed scene, is calculated by multiplying the preset initial value Kp=PTH(base) by ratios K(L), K(f), which have respectively been calculated as above based on the brightness and focus magnification (Step 309). In other words, calculation of the equation PTH=Kp×K(L)×K(f) is done. According to the present embodiment, the peak value average position moving distance PTH is calculated based on the brightness and focus magnification. However, incases where it is possible to find the most appropriate control value beforehand, the initial value PTH(base) of the peak value average position moving distance PTH may be directly used as the peak value average position moving distance PTH.

Next, the reliability of each window Wh is calculated, which begins with initialization of an amount of weight, i.e. a weighting factor (Step 310). The weighting factor is represented in terms of proportion to 100%. For example, the weighting factor may be initialized at 100%. At the same time, a variable m is provided with respect to the calculated peak value average position moving distance PTH so that the weighting factor can be set as a variable. For example, in cases where the weighting factor can be set at four levels, m may be 4, 3, 2, or 1, with 4 being the initial value.

When determining the amount of weight, the ratio to the calculated peak value average position moving distance PTH is set as a changeable value, i.e. a peak value average position moving distance PTH(m), by using the variable m (Step 311). To be more specific, the peak value average position moving distance PTH(m) is found by dividing the peak value average position moving distance PTH calculated in the previous step by the variable m.

When the difference in the absolute value between the peak value average position ΔPS(H)Wh in the scene S(H)Wh and the peak value average position ΔPS(H−1)Wh in the previous scene S(H−1)Wh is greater than the peak value average position moving distance PTH(m), the CPU 17 serving as the determining means judges that camera shake or other similar incident has caused the subject T to move across windows W1-W9 or affected the calculation of the evaluated value (Step 312). When the difference in the absolute value between the peak value average position ΔPS(H)Wh in the scene S(H)Wh and the peak value average position ΔPS(H+1)Wh in the subsequent scene S(H+1)Wh is greater than the peak value average position moving distance PTH(m), the determining means also judges that camera shake or other similar effect has caused the subject T to move across windows W1-W9 or exerted an influence on the calculation of the evaluated value (Step 313). In cases where neither difference in the absolute value exceeds the peak value average position moving distance PTH(m), the determining means judges that there is neither camera shake nor an unfavorable influence on calculation of the evaluated value and, therefore, does not reduce the weighting factor for the pertinent window Wh. The greater the variable m, the smaller the peak value average position moving distance PTH(m) used in comparison, making it more difficult to determine the peak value average position moving distance. The weighting factors to be used are set based on the corresponding peak value average position moving distance PTH(m) (step 315). Should the difference in the absolute value be found to be greater than the set peak value average position moving distance PTH(m) in Step 312 or Step 313, the weighting for the corresponding window Wh is reduced by reducing the weight factor, which is based on the assumption that camera shake is present (Step 315). At that time, the weight factor may be reduced to, for example, as low as 25%. Comparison described above is repeated with the value of the variable m being reduced one at a time from the initial value, e.g. 4 (Step 316), until the variable m becomes 0 (Steps 311-317), while determining the amount of weight based on each variable (314,315). Although the minimum weighting factor is set at 25% according to the present embodiment, the weighting factor is not limited to this particular value; for example, the minimum weighting factor may be set at 0%. Furthermore, according to the present embodiment described above, the peak value average position moving distance PTH(m) is a proportion to the peak value average position moving distance PTH calculated in the previous step. However, a plurality of optimum control values set beforehand may be used if it is possible.

By thus determining whether there has been camera shake by a plurality of criteria, the reliability can be exact and multiple levels.

The operation described above is repeated until calculation for every window W1-W9 is completed (Steps 301-318). By means of weighting described above, the reliability of each window W1-W9 is put into numerical form as a weighting factor.

By applying the process described above to the windows adjacent to the relevant window S(H)Wh, it can be ascertained whether there has been any influence of camera shake or other movement of the target that forms a peak. To be more specific, after the weighting factor, i.e. reliability, of each window Wh is calculated as shown in FIG. 7, Eval FLG is set at 0 (Step 112). Thereafter, in cases where the number of windows Wh with a weighting factor or reliability of at least 100% is not less than a given level, e.g. 50% of all the windows (Step 113), or in cases where there are adjacent windows Wh, each of which has a reliability of not less than a given level, e.g. 100% (Step 114), the determining means judges that there is no movement of the subject T in the pertinent scene. Therefore, without performing weighting of evaluation which will be described later, the determining means performs validity determination by comparing the evaluated value with a preset control value (Step 117).

Should neither condition stipulated in Step 113 or 114 be fulfilled, calculation using weighting factors is performed as described hereunder. After the weighting factors for the windows W1-W9 are calculated, the entire evaluated values of each window W1-W9 are multiplied by the weighting factor calculated for the corresponding window so that weight on each evaluated value reflects on the evaluated value itself (Step 115). At that time, in order to show that calculation using a weighting factor has been performed, Eval FLG is set at 1 (Step 116).

Then, each weighted evaluated value is compared with a preset control value VTH to determine whether it is greater than the control value (Step 117). Thus, a process to determine whether it is valid as an evaluation target (Step 118) or invalid (Step 119) is conducted for every window W1-W9 (Steps 117-120).

Should a plurality of windows found to be valid, the CPU 17 finds a focusing distance by performing focusing distance calculation based on focusing positions, i.e. partial focusing distances, of the valid windows (Step 121).

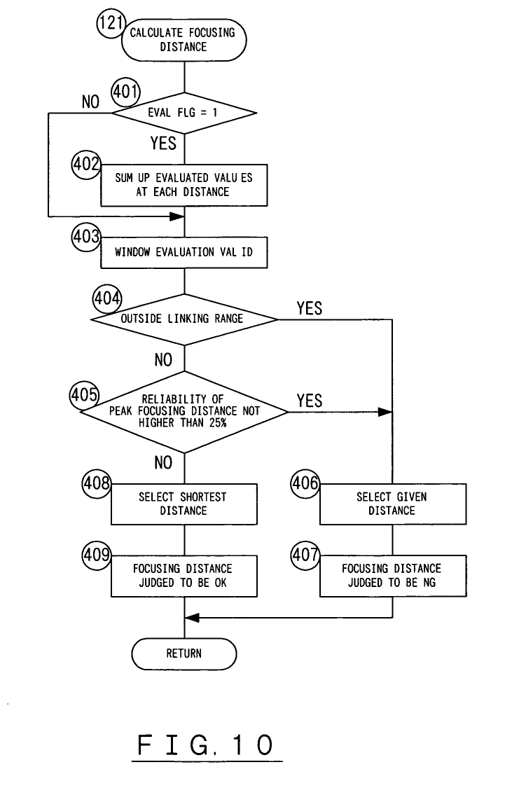

The focusing distance calculation is shown in detail in FIG. 10. First, whether calculation using a weighting factor has been performed is determined from the state of Eval FLG (Step 401). In cases where weighting has been performed, the weighted evaluated values are summed up at each distance (Step 402). In cases the evaluated values have not been weighted, summation is not performed. Peak focusing positions, i.e. peak points, are calculated from the evaluated values (Step 403). In cases where all the peak focusing positions are outside a given photographing range, i.e. a linking range (Step 404), or every peak focusing position has a reliability not higher than a given level, e.g. 25% (Step 405), it is judged that calculation of the subject distance is impossible. In this case, the focusing position, i.e. the focal point at which the lens will be focused, is compelled to be set at a given value, which has been set beforehand (Step 406). At that time, focusing distance determination is judged to be NG (Step 407).

In a situation other than the above, in other words, in cases where one or more peak focusing positions (peak points) are in the given photographing range (Step 404) and such peak focusing position(s) have a reliability greater than a given level, e.g. 25% (Step 405), it is judged that calculation of the subject distance is possible and, from among the valid windows W1-W9, the partial focusing position having the peak point at the closest focusing distance is chosen as the focusing position (Step 408). At that time, focusing distance determination is judged to be OK (Step 409).

When the focusing distance calculation described above includes weighting, the evaluated values are summed up in Step 402 to produce a single evaluated value so that the resulting peak point represents the position of the center of gravity of plural evaluated values. However, the invention is not limited to such a configuration; it is also possible to choose only the windows whose peak points are at a close distance, perform summation for each window, then calculate the partial focal point position, and set it as the focusing position. In cases where weighting has not been performed, it is also possible to choose the partial in-focus position at the closest distance from the windows W1-W9 that hold valid evaluated values, and set the partial focal point position as the focusing position.

Based on the result of determination of focusing distance, (Step 407 or 409) which has been obtained by the focusing distance calculation described above (Step 121), judgment is made as to whether the result of focusing distance determination is OK or NG as shown in FIG. 7 (Step 122). If the result is OK, the lens of the optical system 11 is moved to the set focusing position (Step 123). In case of NG, the lens of the optical system 11 is moved to the aforementioned preset focusing position (Step 124). Thus, the lens can be positioned at the final focusing position.

The embodiment described above is an automatic focusing device used in an image capturing apparatus, such as a digital camera or a video camera and uses image data to perform automatic focusing by a method which calls for dividing a frame into a plurality of areas and determining a focusing position in each area. Even for a scene containing an obstruction to range finding, such as movement of the subject or camera shake, the device according to the embodiment is capable of appropriate range finding and focusing the optical system 11 by detecting blur and using only the optimal data.

To be more specific, when peaks of evaluated values for respective plural areas have been calculated, a conventional device may simply use as the focusing position the partial focal length that is the focusing position at which the highest evaluated value has been recorded. However, by means of evaluated value weighting that takes into account the reliability of the evaluated values, the device according to the invention eliminates partial focal lengths obtained from windows having low reliability due to camera shake or other causes, uses only reliable evaluated values, even if they are not the highest values, to make a judgment and selects the partial focal length at the closest distance from among the evaluated values that have been ascertained to be valid. By using this method, which increases the probability of accurate focusing, the device is capable of making accurate judgment of the focusing position and thereby enables in-focus photography. The device according to the embodiment is particularly valid when used in an optical system 11 of a so-called high-magnification type having a high zooming ratio.

Should the evaluated values themselves prior to weighting be low (e.g. evaluated values affected by noises or other factors or evaluated values in windows in which there is no valid subject), the embodiment is capable of accurate detection of the focal length by treating such windows to be invalid.

To be more specific, giving priority to the short range when calculating a plurality of focal lengths in a plurality of areas is a method generally deemed effective. However, should there be an erroneous peak at a distance shorter than the subject distance due to movement of the subject or camera shake, giving priority to the short range through a conventional process may prevent the location of the subject from being recognized as the focusing position and, instead, cause the erroneous peak to be determined as the focusing position, resulting in failure in setting the correct focusing position. Even if there is an erroneous peak at a distance shorter than the subject distance due to movement of the subject or camera shake, the device according to the embodiment is capable of detecting the movement of the subject or camera shake and using only the optimal data and thereby reliably setting an appropriate focusing position while giving priority to the short range.

There is a conventional method that calls for correcting blur of an image of the subject or camera shake by changing the image detecting area and performing evaluation of the focal point again after the change of the image detecting area. Such a method presents a problem in that it takes a long time to complete calculation of the focusing position, resulting in a missed picture-taking opportunity. The present embodiment, however, enables rapid processing and capture of the shutter release moment, because the focusing position is calculated solely from the information obtained from preset image detecting areas.

By eliminating the need of an acceleration sensor or any other special device or equipment for detecting blur of an image of the subject or camera shake, the embodiment simplifies the structure of the autofocusing device and thereby reduces its production costs.

By increasing the reliability of the calculated plural subject distances, the embodiment makes it possible to devise other algorithms.

As a focal point position is calculated based on evaluated values obtained from preset image detecting areas, the user can avoid any discomfort that would otherwise be felt from the lens focusing on an unintended subject.

As the device is not affected by change in the brightness of images having flicker from such sources as a fluorescent lamp or the like and is therefore free from the problem of fluctuation in peak points of evaluated values of the image, the device according to the embodiment is capable of evaluating the reliability of each one of the plural areas regardless of each evaluated value.

The embodiment described above employs a so-called hill-climbing search range finding method, which calls for obtaining evaluated values at a plurality of positions while operating the optical system 11, and recognizing a peak at the point when the curve of evaluated values changes from upward to downward. Should blur of a subject image occur, the peak point of each window moves inside the window and then into an adjacent window W1-W9. When the peak point of the contrast of the subject T moves from one window to another, the peak value of the evaluated values for the first-mentioned window decreases sharply. By reducing the weight on any window of which there has been a sudden change in the evaluated values with respect to a scene captured previously or immediately afterwards, the embodiment ensures elimination of data containing influence of camera shake and enables the accurate range finding and focusing, using only the most appropriate data.

The present embodiment calls for summation of the peak points of the evaluated values. There is a variation in the peak points of a relatively unfocused image. Therefore, with the present embodiment, the weight can be reduced when given to a window having a wide variation in the peak points or having low peak points from the beginning.

As described above, at each change of the lens position of the optical system 11, the focusing device according to the embodiment measures either the difference between peak values of evaluated values in the same window or the difference in the moving distance between the average position of the peak points in one window and the average position of the peak points in an adjacent window, or measures both kinds of differences. By performing this measurement, the device determines the reliability of the evaluated values of the pertinent window, thereby increasing the reliability of the window. Therefore, in cases where the short range is selected from among focal point positions in a plurality of areas at the time of deciding a final focusing position, range finding is performed with an increased reliability even if camera shake or movement of the subject should occur.

With the features as above, the embodiment increases the reliability of focusing even if there is blur of the subject.

Although the invention is explained referring to the above embodiment, which copes with horizontal movement of a subject T, the invention is also applicable to devices that cope with vertical or diagonal movement of a subject or any combination of these movements.

The image processing circuit 15 shown in FIGS. 1 and 2 may be formed of the same chip as that of another circuit, e.g. the CPU 17, or executed by the software of the CPU 17. By thus simplifying the circuits, their production costs can be reduced. The filter circuits 32 of the image processing circuit 15 may be in any form, provided that they are capable of detecting contrast.

The range finding is not limited to the aforementioned hill-climbing search method and may be executed by scanning the entire range in which the automatic focusing device can operate.

Other than the procedure described above, it is also permissible to sum up the evaluated values of a plurality of plural adjacent windows, after the weighting process shown in FIG. 9. Weighting may also be performed after summation of the evaluated values for a plurality of selected windows.

According to the embodiment one each value is set as the peak value average position moving distance PTH and the control value VTH for the process shown in FIGS. 7 and 9. However, it is also possible to determine these values by selecting from among a plurality of preset values. Furthermore, these values may vary depending on the largeness of the evaluated values or various photographing conditions including the brightness and data of the optical system 11, such as the shutter speed., focus magnification, etc. If such is the case, the optimal values may be selected based on these conditions or found by calculation using these conditions and data as variables in order to perform evaluation suitable for each scene.

When taking a picture using an electronic flash, by obtaining image data of respective scenes with the electronic flash emitting light in sync with each picture taking for focusing, a focusing distance can be detected by the focal length detecting method described above. When an electronic flash is used together with a device according to the invention, photographing is performed under control of light emission from the electronic flash based on the focusing distance and control of quantity of light, i.e. control of the aperture of the camera, shutter speed, etc.

The embodiment described above chooses the partial focal length at the closest distance, i.e. the partial focusing position having the peak point at the closest distance, from among the valid evaluated values, and sets such a partial focusing position as the focusing position (Step 408). However, the invention is not limited to such a process; in accordance with the intention of the user (to be more specific, in response to operation by the user, i.e. the photographer, to select the photographing mode), a partial focusing position other than the closest partial focusing position may be selected as the focusing position directly by the photographer or automatically as a result of selecting function of the control means in response to operation by the photographer. Furthermore, according to the embodiment, when the result of focusing distance determination is NG (Step 122), the lens of the optical system 11 is moved to a preset focusing position (Step 124). However, it is also permissible to set a plurality of focusing positions beforehand and move the lens of the optical system 11 to one of the present focusing positions in accordance with the intention of the photographer, i.e. operation by the photographer to select the photographing mode.

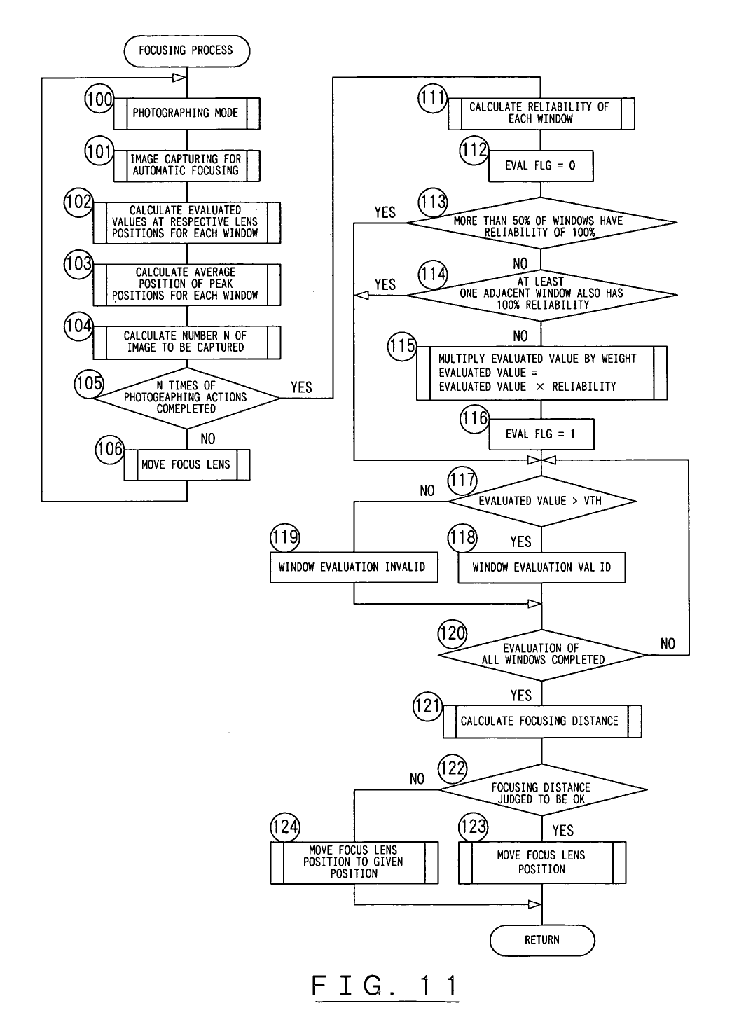

Next, another embodiment of the invention is explained referring to FIGS. 11 through 13.

According to this embodiment, in addition to the short-range priority mode (the normal mode), which is a normal photographing mode, the photographer may also select the long-range priority mode; the photographer may even designate a desired range of photographing distance, i.e. a linking range, by means of a mode that can be called a far distance mode or an infinity mode. In the description hereunder, the explanation of the same elements or components as those of the embodiment shown in FIGS. 1 though 10 is omitted.

The device according to the present embodiment includes an operating means which is a photographing mode selecting means to permit the photographer to choose the long-range priority mode or the far distance mode. Its function is similar to the function of focusing shown in the flow chart of FIG. 7 except that, as shown in FIG. 11, a desired photographing mode is set (Step 100) prior to taking a picture for automatic focusing processing (Step 101) and that the details for focusing calculation (Step 121) are different.

When focusing process involves designation of a range of photographing distance, it is necessary to know, as criteria for focusing, the range of photographing distance through the lens driving range based on the photographing modes of the image capturing apparatus 10. Should the photographing modes of the image capturing apparatus 10 include a normal mode which covers, for example, 50 cm to the infinity, the lens driving range is set for this mode. If the image capturing apparatus 10 has other modes than the normal mode, such as a far distance mode (an infinity mode), a macro mode, etc., an operating means to enable the photographer to select any of these modes, in other words an operating means that enables the photographer to set the range of photographing distance, i.e. the lens driving range, is provided.

In the process of focusing, whether determination of the final focal length gives priority to the short range or the long range has to be decided as criteria for focusing. This is determined by the photographer selecting a photographing mode by operating the operating means of the image capturing apparatus 10. Should the photographing mode of the image capturing apparatus 10 be set at the long-range priority mode, setting is made to employ a longest-distance selecting mode for driving the lens so that the focusing distance corresponds to the longest distance in a captured image. In cases where the short-range priority mode has been selected, the focusing device is set at the shortest-distance selecting mode so that the focusing distance corresponds to the shortest distance in a captured image, thereby enabling photography with priority given to the short range, which is the mode generally employed.

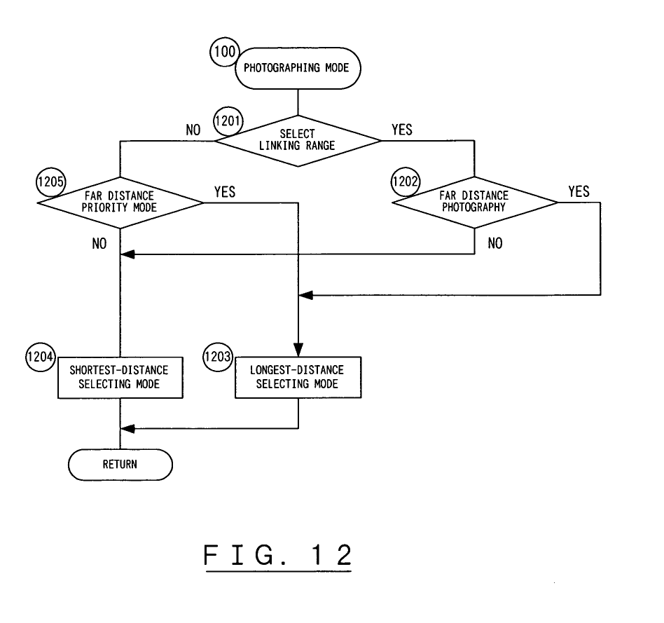

The process of setting the desired photographing mode shown in FIG. 11 (Step 100) begins with ascertaining whether the photographer has designated the range of photographing distance as shown in FIG. 12 (Step 1201). In cases where the mode for selecting the range of photographing distance has been selected, judgment is made as to whether the far distance photographing mode has been selected (Step 1202). In cases where the far distance mode has been selected, the longest-distance selecting mode is selected (Step 1203). In cases where the far distance mode has not been selected (in other words when either the macro mode or the normal mode has been selected), the shortest-distance selecting mode is selected (Step 1204). In short, the photographing mode, i.e. whether priority is given to the short range or the long range, is automatically decided in these steps based on the range of photographing distance.

In cases where the mode for selecting the range of photographing distance has not been selected in Step 1201, judgment is made as to whether long-range priority mode has been selected (Step 1205). If the photographer has selected the long-range priority mode, the longest-distance selecting mode is selected (Step 1203). In cases where the long-range priority mode has not been selected, the shortest-distance selecting mode is selected (Step 1204). In other words, the photographing mode that will determine the final focusing distance with priority on the intention of the photographer is selected in these steps.

After the process from Step 101 to Step 120 shown in FIG. 11 is completed, the final focusing calculation in the focusing process is determined based on the selected photographing mode.

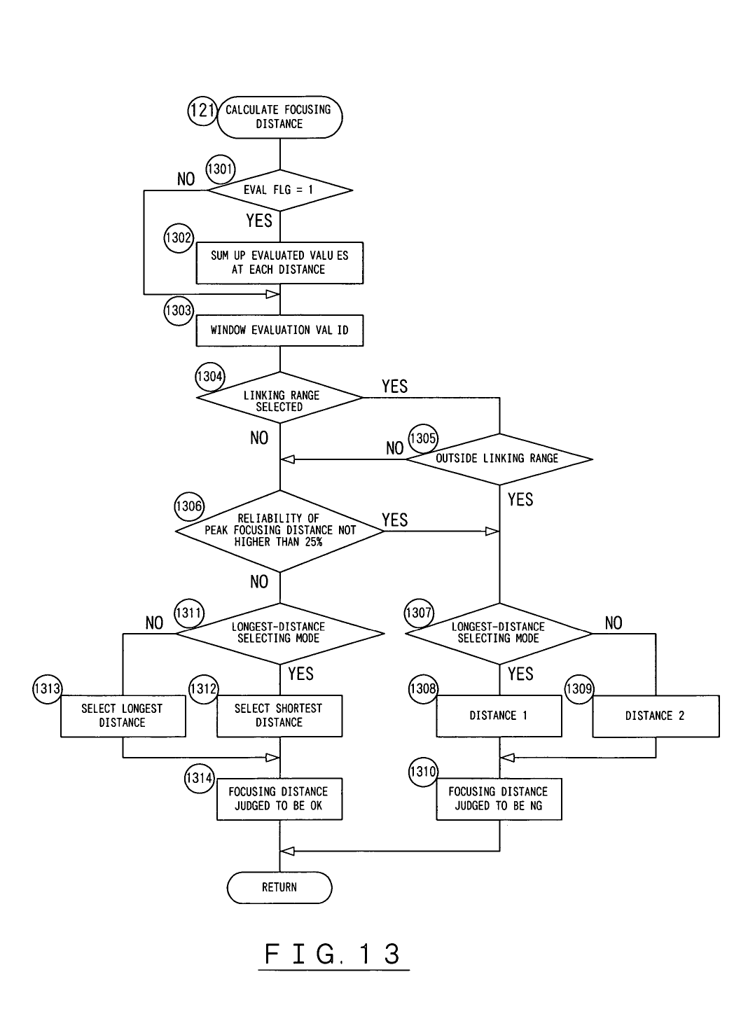

In step 121, focusing distance calculation shown in FIG. 13 is performed instead of the steps shown in FIG. 10.

First, in the same manner as the process shown in detail in FIG. 10, whether calculation using a weighting factor has been performed is determined from the state of Eval FLG (Step 1301). In cases where weighting has been performed, the weighted evaluated values are summed up at each distance (Step 1302). In cases the evaluated values have not been weighted, summation is not performed. Peak focusing positions, i.e. peak points, are calculated from the evaluated values (Step 1303). In cases where the photographing range, i.e. the linking range, has been set based on the photographing mode selected in Step 100 shown in FIG. 11 (Step 1304), should all the peak focusing positions be outside the preset photographing range (Step 1305), or every peak focusing position have a reliability not higher than a given level, e.g. 25% (Step 1306), it is judged that calculation of the subject distance is impossible (Step 1307). In this case, the focusing position, i.e. the focal point at which the lens will be focused, is compelled to be set at a given value, based on the photographing mode set in Step 100. The photographing mode is either the shortest-distance selecting mode or the longest-distance selecting mode. Therefore, in cases where calculation of the subject distance is judged to be impossible, it is determined whether the current mode is the longest-distance selecting mode (Step 1307). When the current mode is the longest-distance selecting mode, a given distance, i.e. Distance 1, is set (Step 1308). When the current mode is not the longest-distance selecting mode, another given distance, i.e. Distance 2, is set (Step 1309). Distance 1 is greater than Distance 2 (Distance 1>Distance 2). At that time, focusing distance determination is judged to be NG (Step 1310).

Should every peak focusing position have a reliability not higher than a given level, e.g. 25% (Step 1306) in the situation where the linking range has not been set based on the photographing mode determined in Step 100 shown in FIG. 11 (Step 1304), calculation of the subject distance is judged to be impossible (Step 1307), and the same procedure as above is followed (Steps 1308-1310).

In cases other than the previously discussed Steps 1304-1305, to be more specific, in cases where the linking range has been set (Step 1304), one or more peak focusing positions (peak points) are in the range of photographing distance that corresponds to the set photographing mode (Step 1305), and such peak focusing position(s) in the photographing range have a reliability greater than a given level, e.g. 25% (Step 1306), calculation of the subject distance is judged to be possible. In order to decide the peak point, which photographing mode has been selected in Step 100 is determined. Should the longest-distance selecting mode be the selected mode (Step 1311), the partial focusing position having the peak point at the longest distance is selected from among the valid windows W1-W9 and set as the focusing position (Step 1312). Should the longest-distance selecting mode be not the selected mode (Step 1311), in other words in cases where the current mode is the shortest-distance selecting mode, the partial focusing position having the peak point at the shortest distance is selected from among the valid windows W1-W9 and set as the focusing position (Step 1313). At that time, focusing distance determination is judged to be OK (Step 1314).

Should there be at least one peak focusing position having a reliability higher than a given level, e.g. 25% (Step 1306) in the situation where the linking range has not been set based on the photographing mode determined in Step 100 shown in FIG. 11 (Step 1304), calculation of the subject distance is judged to be possible, and the same procedure as above is followed (Steps 1311-1314).

According to the result of focusing distance determination (Step 1310 or 1314) which has been obtained by focusing distance calculation described above (Step 121), as shown in FIG. 7, judgment is made as to whether the result of focusing distance determination is OK or NG (Step 122). If the result is OK, the lens of the optical system 11 is moved to the calculated focusing position (Step 123). In case of NG, the lens of the optical system 11 is moved to the aforementioned preset focusing position, i.e. Distance 1 or Distance 2 (Step 124). Thus, the lens can be positioned at the final focusing position.

As described above, the present embodiment enables focusing to the long range side according to the intention of the photographer and thereby facilitates image capturing focused to the long range side as intended by the photographer. To be more specific, based on the range of photographing distance, the photographer can choose a desired photographing mode from among the so-called normal mode, the mode aimed at long distance photography, e.g. the far distance mode or the infinity mode, and the mode for enabling the lens to be focused at any distance within the range the designated range of photographing distance covering the entire range of photographing distance for which the lens is designed while giving priority to either a short distance or a long distance. As a result of this feature, the photographer can take desired pictures easily. As a focusing position is determined using data which has been obtained from a plurality of image areas and ascertained to be free from any undesirable influence of sudden movement of the subject or the like, in other words data which has been judged to be valid for focusing, pictures can be taken that exactly meet the photographer's expectation. With the features as above, the present embodiment provides a method of automatic focusing which calls for dividing a frame into a plurality of areas and determining a focusing position in each area. Even with a scene containing an obstruction to range finding, such as movement of the subject or camera shake, the method according to the embodiment is capable of appropriate range finding and focusing of the optical system 11 by detecting blur and using only the optimal data, and, therefore is capable of increasing the accuracy of focusing.

Giving priority to the short range when calculating a plurality of focal lengths in a plurality of areas and determining a final focal length is a method generally deemed effective. However, should there be an erroneous peak at a distance shorter than the subject distance due to movement of the subject or camera shake, giving priority to the short range through a conventional process may prevent the subject from being recognized as the focusing position and, instead, cause the erroneous peak to be determined as the focusing position, resulting in failure in setting the correct focusing position. When taking a picture of a subject located at a long distance rather than at a short distance, it is possible in this case too that movement of the subject or camera shake may cause an erroneous peak to be mistaken for the focusing position; the focusing position may be erroneously set at a peak located closer than the real peak or at a peak located even farther than the long distance intended by the photographer (for example, a position farther than the subject that is located farthest in the captured image). In either case, focusing is not done as the photographer intended. However, even if movement of the subject or camera shake generates an erroneous peak at a location closer or farther than the subject distance, the embodiment enables the reliable setting of an appropriate focusing position by detecting the movement of the subject or camera shake and using only the correct evaluated values while giving priority to the short range or long range based on the selected photographing mode.

In cases where the range of photographing distance is set at the normal mode, the shortest-distance selecting mode is automatically selected. In cases where the range of photographing distance is set at the long distance mode, the longest-distance selecting mode is automatically selected. As the subject at the longest distance is selected for the final focusing position from among a plurality of image areas without the shortest distance in the range of photographing distance set by the long-distance mode being erroneously selected as the final focusing position, pictures can be taken as desired by the photographer.

In cases where the configuration of the device permits mode selection between the long-range priority mode and the short-range priority mode from within the entire range of photographing distance, it is sufficient for the photographer to simply choose the long-range priority mode; there is no need of complicated operation by the photographer to visually determine the photographing range (for example, whether the subject is in the macro range or the normal range) beforehand. Together with accurate focusing that calls for determining the final focal length after evaluating the reliability of the data, the embodiment enables accurately focused photography that meets the photographer's intention.

Furthermore, the use of the long-range priority mode also enables accurate focusing to a long distance other than the infinity.

As the method described above calls for calculating and evaluating the distance to the subject in each one of plural areas, it prevents failure in focusing even if the subject has moved or background blur has occurred. Furthermore, even under severe conditions that impair accurate evaluation of the focusing positions, such as when range finding is impossible because contrast evaluated values are too low in all the image areas to produce valid focusing positions, pictures can be taken as desired by the photographer by designating a given distance as the focusing distance based on the photographing mode.

As the present embodiment calls for meeting the photographer's intention, which has been made clear by the selection between short-range priority and long-range priority, the embodiment enables the intuitive confirmation of the focal length prior to an actual photographing action without using complicated algorithms and eliminates the necessity of a special device, such as an optical finder of a single-lens reflex camera or a device that uses a calculation component and serves for enlarged display on an LCD panel. Therefore, compared with a conventional device including a mechanism that permits the camera to automatically recognize the focal length in an image by using a learning function as well as the selection between short-range priority and long-range priority in order to determine the focal length, the embodiment offers a device having a simplified structure at reduced production costs.

The driving range of the lens varies with respect to the range of photographing distance for which the lens is designed, depending on fluctuation resulting from the lens magnification, a change resulting from a change in aperture, as well as temperature, position and other conditions of the lens barrel, which supports the lens. Therefore, taking into consideration the degree of change resulting from changes in these various conditions in addition to the driving range calculated from the range within which the lens is designed to be focused, the optical system 11 is provided with overstroke ranges at the short-range end and the long-range end respectively. An overstroke range is a range in which the lens is permitted to move by the distance corresponding to the degree of change. Furthermore, the control means, which is comprised of the CPU 17 or the like, is adapted to be capable of driving the lens position of the focus lens unit into an overstroke area.

With the structure as above, in the longest-distance selected mode, even if the in-focus position is near the long-range end of the lens driving range and the lens barrel is oriented towards the long distance side, the range of photographing distance is ensured by driving the lens of the focus lens unit into the overstroke area at the long-distance end.

Furthermore, in the shortest-distance selected mode, even if the in-focus position is near the short-range end of the lens driving range and the lens barrel is oriented towards the shortest distance side, the range of photographing distance is ensured by driving the lens of the focus lens unit into the overstroke area at the short-distance end.

As described above, the embodiment enables the photography with possible deviation of the focal point occurring near the short-range end or long-range end taken into consideration, thereby easily ensuring the range of photographing distance without the need for a means of control, mechanical or software, for high precision distance correction. Therefore, the embodiment enables reduced production costs.

According to the embodiment shown in FIGS. 11 through 13, the photographer may freely set the range of photographing distance and select the long-range priority mode. However, the device may be adapted to permit only one of the two types of selection, i.e. selection of the range of photographing distance or selection of the long-range priority mode, to simplify the structure and operation of the device.

The present invention is applicable to various image capturing apparatuses, including, but not limited to, digital cameras and video cameras.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A method of detecting a focal length, comprising:
setting a plurality of image detecting areas adjacent to one another;
obtaining multiple image data while changing the focal length of an optical system;
calculating from said multiple image data a partial focal length for each image detecting area based on which image data the peak value of contrast evaluated values has been recorded in, and the reliability of each image detecting area based on the position at which said peak value has been recorded moving across the multiple image data; and
selecting a focal length from said partial focal lengths and at least one reference focal length, said focal length being selected based on the reliability and the evaluated values of each respective image detecting area.

2. A method of detecting a focal length as claimed in claim 1, further comprising:
weighting evaluated values performed based on the calculated reliability, and
selecting a focal length from among the partial focal lengths of the image detecting areas based on the evaluated values thereof to which weighting has been applied.

3. A method of detecting a focal length as claimed in claim 1 or claim 2, wherein:
should a position at which a peak value has been recorded move from at least one image detecting area that contains said position into at least one other image detecting area, the reliability of the first-mentioned image detecting area is reduced.

4. A method of detecting a focal length as claimed in claim 1 or claim 2, wherein:
should a position at which a peak value has been recorded move more than a given distance across plural image detecting areas that contain said positions at which peak values have been recorded, the reliability is reduced.

5. A method of detecting a focal length as claimed in claim 1 or 2, wherein:
in cases where image data containing a great peak value has been obtained, the number of images to be subsequently obtained in the form of data is reduced.

6. A method of detecting a focal length as claimed in claim 1 or 2, wherein:
a peak point movement determining value, which is used at the time of calculation of a reliability for determining whether a position at which a peak value has been recorded has moved is a variable calculated based on photographing conditions.

7. A method of detecting a focal length as claimed in claim 1 or 2, wherein:
a plurality of peak point movement determining values are set for determining at the time of calculation of a reliability whether a position at which a peak value has been recorded has moved, and the peak point movement determining values are sequentially compared with the multiple image data.

8. A method of detecting a focal length as claimed in claim 1 or 2, wherein:
the focal length is selected from among the partial focal lengths in the image detecting areas, either the partial focal length at the shortest distance or the partial focal length at the longest distance, in accordance with the operator's choice.

9. A method of detecting a focal length as claimed in claim 1 or 2, wherein:
a controller selects as the focal length either the partial focal length at the shortest distance or the partial focal length at the longest distance from among the partial focal lengths in the image detecting areas in accordance with the operator's selection of the range of photographing distance.

10. A method of detecting a focal length as claimed in claim 1 or 2, wherein:
the focal length is selected based on the reliability between a partial focal length selected from among the partial focal lengths in the image detecting areas and a given focal length.

11. A method of detecting a focal length as claimed in claim 9, wherein:
the focal length is selected, based on the reliability, between a partial focal length selected from among the partial focal lengths in the image detecting areas and a given focal length that has been set as a result of the operator's choice.

12. A focusing device, comprising:
an image pickup device,
an optical system for forming an image on the image pickup device,
an optical system driver for changing the focal length of the optical system, and
an image processor for processing image data output from the image pickup device and controlling the optical system driver, wherein:
the image processor is adapted to:
obtain multiple image data while changing the focal length of the optical system by controlling the optical system driver,
define a plurality of image detecting areas adjacent to one another in each one of the multiple image data obtained as above,
calculate a partial focal length for each image detecting area based on which image data the peak value of contrast evaluated values has been recorded in,
calculate a partial focal length for each image detecting area based on which image data the peak value of contrast evaluated values has been recorded in,
calculate the reliability of each image detecting area based on the position at which said peak value has been recorded moving across the multiple image data, and
select a focal length from a group consisting of said partial focal lengths and at least one given focal length, said focal length being selected based on the reliability and the evaluated values of each respective image detecting area.

13. A focusing device as claimed in claim 12, herein:
further comprising a photographing mode selector adapted to make a selection between a short-distance priority mode and a long-distance priority mode, and
wherein the image processor is adapted to select the focal length with priority given to either the partial focal length at the shortest distance or the partial focal length at the longest distance in accordance with the result of operation of the photographing mode selector.

14. A focusing device as claimed in claim 13 wherein:
the optical system driver is capable of driving the optical system into an overstroke range, which is a range beyond the range of focal length for which the optical system is designed.
